(19) United States
(12) Patent Application Publication
(10) Pub. No.: US 2003/0230663 A1
(43) Pub. Date: Dec. 18, 2003

(54) Method and installation for treatment of a band product

(76) Inventor: Alain Douaud, Lyon (FR)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/423,033

(22) Filed: Apr. 25, 2003

(30) Foreign Application Priority Data
Apr. 26, 2002 (FR) 0205318

(51) Int. Cl. B65H 18/00; B65H 20/34; B65H 23/195; B08B 1/02

(52) U.S. Cl. 242/417; 226/1; 134/15

(57) ABSTRACT

The invention relates to a method for driving a band product through an installation comprising at least three successive sections, respectively a feeding section (1), a treatment section (2) placed between two tensioners, respectively upstream (61) and downstream (61′) and a discharge section (3).

According to the invention, a variation in the running speed in the treatment section (2) is compensated for immediately by a corresponding variation in the band length (44) situated between the output end (20′) of the treatment section (2) and the downstream tensioner (61′), for maintaining permanently a band length substantially constant between said output end (20′) and the upstream tensioner (61), without any significant variation in the traction load applied to the band (4) in each treatment tank (21).

The invention applies especially to the pickling of metal bands.

The invention relates to a method and an installation for treatment a band product and applies especially to the pickling of a metal band.

It is generally known that the manufacture of a metal product requires a so-called “hot processing” of a raw product obtained by mould casting or by continuous casting and undergoing hot transformation by forging and/or hot rolling. The product thus obtained is subject, then, to cold transformation comprising various steps depending on the nature of the metal and on the quality of the product to be manufactured.

In the case of the production of metal bands, in particular steel, there is formed, during the cooling phase, more or less substantial a layer, composed of oxides, which must be eliminated by an appropriate treatment. It is advantageous, in particular, to perform chemical pickling while soaking the band, for a preset time, in a treatment fluid such as an acid liable to dissolve the oxides while transforming them into a salt of the acid.

Generally, this pickling is performed by running the band, successively, through one or several tanks, filled with acid. The treatment duration which depends on the immersed length and on the running speed may also vary.

In an old so-called ‘push-pull’ method, the pickling tank is placed between two coiling devices, respectively for unwinding a coil and for rewinding thereof after running in the tank.

However, for increased productivity, it is possible to perform continuous treatment of several successive coils. In such a case, upon completion of the unwinding cycle of a coil, the tail thereof, i.e. its downstream end in the running direction, is fixed to the head of a new coil which is thus driven towards the treatment section. Similarly, the discharge section comprises means for shearing the band in order to enable discharge of the coil upon completed winding and engagement on the winder of the head of the following coil. There is provided a long continuous band which runs at a certain speed between an uncoiler fitted with means for replacing a coil with a following one, and a coiler connected to means for discharging wound coils.

Such a continuous line installation comprises therefore, in the running direction, at least three successive sections, respectively, a feeding section, a treatment section comprising one or several successive tanks and a discharge section.

It is, however, necessary to stop the running in the feeding section to perform the junction of two successive coils, as well as in the discharge section to discharge the wound coil and engage the following band on the coiling device. Still, the efficiency of the pickling depends obviously on the soaking time of the band in the tanks. Therefore, to obtain homogeneous pickling, the running of the band in the tanks must be continued, if possible at the same speed, during the stoppage time in the feeding section or in the discharge section.

The continuous pickling lines must therefore be fitted with means for accumulating a variable band length, enabling to store in advance, upstream of the treatment section, a band length sufficient to feed the treatment section during the necessary stoppage time, in the feeding section, for the junction of the tail of a coil with the head of the following coil.

Similarly, upon completion of a coiling cycle of a coil, the band must be shorn to enable the discharge of the wound coil and the head of band thus constituted must be engaged on the coiler for winding the following coil. During the stoppage time necessary to these operations, the running of the band is carried on in the pickling tanks and the band length thus produced is stored in an accumulator placed upstream of the discharge section.

Previously, the accumulators were composed of deep shafts wherein a band was allowed to unwind, under its own weight, into the shaft and was then pulled at the exit thereof, for example by pinching rolls.

The speed difference between the input and the output of the shaft then enables to vary the length of the loop and therefore the band length accumulated.

In some cases, the band was even allowed to accumulate, in superimposed folds, at the bottom of the shaft, but this causes significant friction and a risk of deterioration which may only be mitigated by filling the shaft with water. To avoid this situation, it is preferable that the band forms inside the shaft, a single loop between two deflecting rolls. The band length accumulated then depends on the depth of the shaft but may be increased by using several successive shafts, called “looping pits”.

Such an arrangement requires only relatively simple traction control devices, but may only be used when a high quality level is not required and for installations having a small or medium capacity.

Conversely, it is necessary, in a continuous line installation, to use accumulators of another type, which may have a very large capacity.

Indeed, the treatment installations, operating as a continuous line in particular for pickling, were only provided, until now, for very large productions, which may exceed 1 million tons per annum, for example.

Since the coils have a limited weight in the order of some twenty tons, these must follow one another rather rapidly, which requires stopping the running frequently to enable, upstream, to weld the following coil and, downstream, to discharge the wound coil.

Moreover, to enable large production, the running speed must be rather high and, to obtain sufficient soak time, the length of the treatment section should be increased, which comprises several successive tanks.

It is therefore necessary to place accumulators of very large capacity upstream and downstream of the treatment section.

For example, for a running speed of 250 m/min, a stoppage time of 1.5 minutes for the replacement of a coil requires a capacity of accumulation of approximately 400 m.

Such accumulators are well-known and comprise, generally, a set of fixed intermediate rolls and a set of mobile rolls mounted on a looping carriage in order to form several superimposed belts, running in opposite directions. Horizontal movement of the carriage in a direction or in the other enables, then, to increase or to decrease the band length running on the rolls. However, to avoid any contact between two superimposed belts, respectively out and return, a series of separating arms must be interposed between said belts, said arms being distributed along of the path of the looping carriage and having therefore to move away to enable the passage of said carriage (FR-A-2778350).

The operation of such an accumulator requires accurate control of the traction load applied to the band so that the different belts of said band remain stretched correctly throughout the movement of the looping carriage. Each accumulator must therefore be connected to two tensioners placed respectively upstream and downstream and composed, usually, of S-shaped mounted rolls.

Besides, the treatment section may be composed of relatively deep tanks, filled with a pickling liquid wherein the band is dipped by forming more or less long a loop. A difference between the running speeds at the input and at the output of the tank causes, indeed, a corresponding variation in the band length immersed.

However, a deep tank requires a large quantity of treatment liquid and, for some time, it has been suggested to use, for pickling, relatively flat tanks wherein the band has a little deflection, which diminishes the quantity of liquid necessary in the tank. To reduce the capacity of a tank still further, said tank, may besides, be fitted with a curved bottom in order to match substantially the catenary shape of the loop.

It is known, indeed, that a band stretched between two resting points, under the effect of its own weight, forms a “catenary” curve whereof the lower section is placed beneath the levels of the resting points, at a certain height called [symbol] dip [symbol] , which depends on the length of the loop stretched between both resting points.

Still, the traction load to be applied at each resting point in a catenary-shaped curve depend on the orientation of the end of the loop and becomes very important when the band must follow relatively stretched a curve. The dip of the catenary curve is therefore very sensitive to a variation in the traction loads applied to the input and to the output of the tank. Still, in case of contact with the bottom of the tank, the band, which runs at high speed, may be damaged. To avoid any defects, it is therefore necessary to control with precision the traction load applied at both ends of the band so that the length of the catenary curve and the level of its lower section remain substantially constant.

To do so, the band must be held stretched by two tensioner devices, respectively an upstream tensioner placed ahead, in the running direction, of the input end in the treatment section and a downstream tensioner placed behind the output end of the treatment section.

In such a case, the downstream tensioner determines the running speed of the band which is retained by the upstream tensioner. An adjustment of the torques applied to tensioners enables to control with precision the tension of the band in order to keep constant the length thereof and, consequently, the dip in each tank.

However, the traction levels to be provided in the tanks are not the same as in the accumulators and both tensioners placed upstream and downstream of the treatment section added therefore to those which are connected to the accumulators.

The document U.S. Pat. No. 4,886,199 describes a simplified arrangement wherein the upstream accumulator and the downstream accumulator use the same looping carriage or two carriages whereof the movement is interconnected.

It is thus possible to keep constant speed in the treatment section, whereas the upstream accumulator is being emptied while the downstream accumulator is being filled and conversely.

Such an arrangement enables to reduce the number of tensioners and to do away with the means for controlling the movement of the looping carriage since it is effected by the traction exerted by the band. Consequently, however, it is not possible to control with precision this traction load.

The provision of the document U.S. Pat. No. 4,886,199 may therefore be used, for example, for continuous rolling, but would not enable, in the case of a pickling line using relatively flat tanks, to keep the traction load at sufficient constant a level to avoid any risk of contact of the band with the bottom of the tank.

On the other hand, such an installation still requires the use of two accumulators having a large capacity which are very cumbersome and expensive devices.

Such pieces of equipment, whereof the immobilisation is very costly, are therefore profitable only for large production lines or lines coupled on the tandem roll stands. Consequently, until now, continuous pickling line has only been provided for large annual tonnages of descaled bands, for example ranging between 1 and 2 million tons per annum, the conventional so-called [symbol] push-pull [symbol] technique being used normally in smaller capacity installations.

Still, the evolution in the metallurgy market shows that the qualities imposed on the materials, in particular rolled steels, are more and more accurate and that the customers' requirements should be met quite flexibly.

It has therefore appeared interesting to realise installations having substantially the same advantages as a continuous large capacity line, in particular for the quality of the product obtained and remaining, however, profitable, the same for a small or medium production ranging, for example, between 500,000 and 750,000 tons per annum.

The invention intends therefore to solve this problem thanks to a new method for driving the band in a continuous line installation, enabling to use pieces of equipment which are much simpler and more economical than in conventional large capacity installations.

Moreover, the provisions according to the invention enable to use modern technologies such as small height pickling tanks with rapid acid recirculation without any risk of deterioration of the band.

The invention applies therefore to an installation comprising, generally, at least three successive sections respectively a feeding section, a treatment section by passing the band in at least one oblong tank containing a treatment liquid and a discharge section, said treatment section being connected to an upstream tensioner and to a downstream tensioner placed respectively ahead of the input end and behind the output end of the section.

According to the invention, any variation in the running speed in the treatment section is compensated for immediately, at least during an acceleration or deceleration phase, by a corresponding variation in the band length situated between the output end of the treatment section and the downstream tensioner, in order to maintain permanently a band length substantially constant between said output end of the treatment section, and the upstream tensioner, without any significant variation in the traction load applied to the band between both tensioners.

Particularly advantageously, to enable to stop the running of the band throughout a discharge cycle of a coil, upon completed winding, the running speed in the treatment section is reduced to a minimum value compatible with the quality of the band and the band length running, at said minimum speed, during this stoppage time, is put aside in an accumulator with a capacity corresponding to said minimum speed, which is interposed between the output end of the treatment section and the downstream tensioner.

Similarly, to enable to stop the running of the band during a replacement cycle with a new coil, of a coil upon completed unwinding, the running speed in the treatment section is reduced to a minimum value compatible with the quality of the band and the band length running, at said minimum speed, during this stoppage time, is put aside in an accumulator having a capacity corresponding to said minimum speed, which is interposed between the output of the feeding section and the upstream tensioner.

In all cases, thanks to the invention, the dynamic effect of a variation in the running speed in the treatment section is immediately compensated for by a corresponding variation in the band length situated between the output of the treatment section and the downstream tensioner, without any modification of the traction load and, consequently, of the dip of the catenary curve formed in each tank.

For the replacement or the discharge of a coil, this length put aside may be limited by reason of the reduced speed in the tanks to a minimum value and it is thus possible to use an accumulator which is simpler and more economical than in conventional continuous lines.

The invention also covers an installation for the implementation of the method, comprising two tensioners placed respectively upstream and downstream of a treatment section. According to the invention, the installation comprises means for controlling a variation in the band length running between the output end of the treatment section and the tensioner downstream, for maintaining, permanently, a band length substantially constant between said output end and the upstream tensioner, without any significant variation in the traction load applied to the band between both tensioners, respectively upstream and downstream.

According to another particularly advantageous feature of the invention, the accumulation device interposed between the output end of the treatment section and the downstream tensioner may constitute, on the one hand, a means for keeping, permanently, a band length and a traction load substantially constant between the input end and the output end of each tank and, on the other hand, a means for reserving a band length sufficient for maintaining a minimum running speed of the band in the treatment section throughout a stoppage time of the running in the discharge section.

In a preferred embodiment, such an accumulator has a maximum accumulation capacity corresponding to the band length running for the duration of a discharge cycle of a coil, at reduced running speed in the treatment section. For example, the accumulation capacity may be a few tens of metres at the most. Preferably, the duration of a discharge cycle is in the order of 1 to 2 minutes and the running speed, during this cycle, is reduced to approximately 10 m/min, whereas the capacity of the accumulator may be 15 to 20 m.

Particularly advantageously, such a band accumulator comprises an intermediate roll whereon run two belts of the band, respectively out and return, whereas said intermediate roll is movable, preferably horizontally, between two accumulation positions, respectively a minimum accumulation retracted position and a maximum accumulation extended position.

In such a case, the first accumulator placed between the output of the feeding section and the upstream tensioner, is advantageously of the looping pit type.

The invention thus enables to realise a pickling installation which is particularly simple and economical and may operate as a continuous line, profitably for a production in the order of 500,000 to 750,000 tons per annum.

But the invention also covers other advantageous features which will appear in the following description of a particular embodiment given for exemplification purposes and represented on the appended drawings.

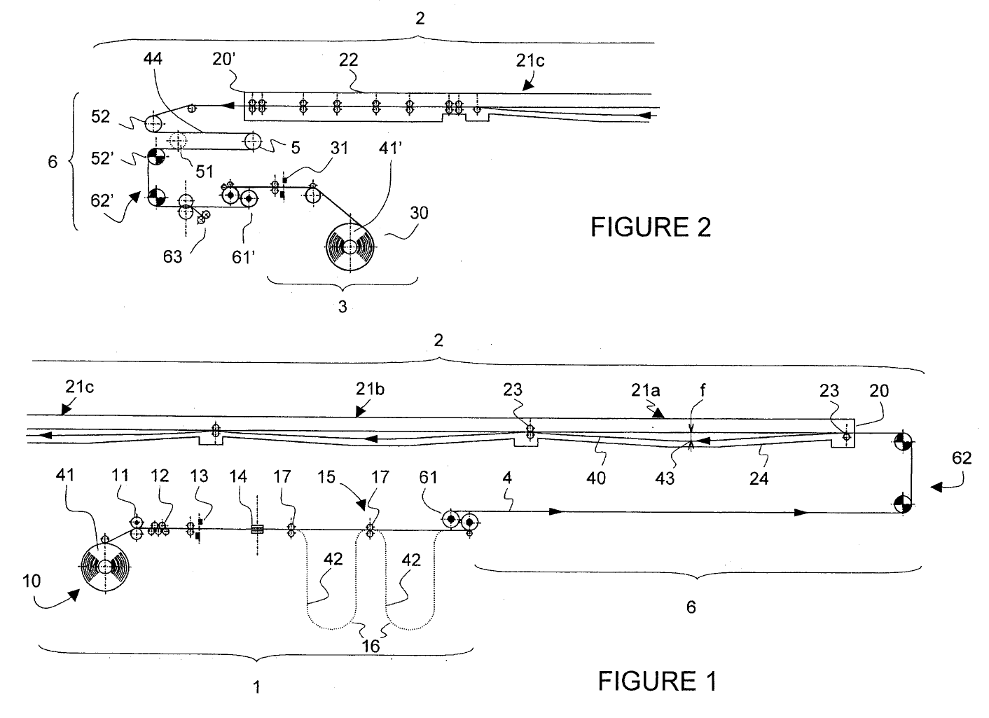

FIG. 1 shows schematically a first part of an installation according to the invention comprising a feeding section and the beginning of a treatment section.

FIG. 2 shows schematically the second part of such an installation comprising the output of the treatment section and a discharge section.

FIGS. 1 and 2 represent therefore schematically the whole chemical pickling installation of a metal band comprising three sections, respectively, a feeding section 1, a treatment section 2 and a discharge section 3 placed successively along a longitudinal running direction of a metal band 4.

The feeding section 1 comprises, conventionally, an uncoiler 10 receiving a coil to be processed 41, pinching rolls 11 for unwinding the coil 41, and a unbending and straightening block 12 enabling to straighten the band emerging from the coil and to perform rough planing to prevent the band from catching fixed sections, in particular when running into the pickling tanks.

Cropping shears 13 enable to cut the head and tail of each coil, in order to eliminate them.

The treatment section 2 is composed of several pickling tanks 21, generally three or four tanks, which are followed by a rinsing device 22.

As represented schematically on the drawings, flat tanks having a little depth relative to their length may be used, each tank being fitted, at its input and at its output, with deflector rolls 23 between which the band follows a catenary curve whereof the lowest section 43 runs at a small distance from the bottom 24 of the tank, which may be fitted with a series of spaced resting points to avoid any direct contact.

Such flat tanks, enabling to reduce the necessary quantity of treatment liquid, have been known for a long time and have been subject to various improvements.

For example, to limit the volume of the tank still further, it is possible to confer to the bottom 24 thereof a curved shape parallel to the catenary curve followed by the band between both ends of the tank.

Moreover, it is possible to inject directly the treatment liquid on the running band by means of a set of nozzles arranged in order to match the shape of the curve formed by the band in the tank, according to an arrangement described in the document FR-A-2 784 998, of the same applicant. The quantity of liquid used is thus highly reduced. Besides, the projection of the acid under pressure increases the efficiency of the treatment.

Generally, the number of tanks and theirs lengths are determined relative to the maximum running speed foreseen, taking into account the type of band to be treated, in particular its format and the nature of the material and the type of acid used. Moreover, the treatment section 2 is fitted with system for circulating and controlling the flow rate of the pickling fluid in each tank, for regeneration of the acid in order to keep optimum chemical treatment conditions. Such means are well known and are therefore not represented on the drawing.

To enable the use of tanks of relatively small capacity, it is necessary to control the level of traction of the running band. Indeed, for the dip f of the catenary curve followed by the band in each tank to remain small with respect to the distance between the deflector rolls 23, 23′ placed respectively at the input and at the output of the tank, the band must be subject to relatively high traction and a reduced traction load, even a relatively small one, increases the band length between both deflector rolls 23, 23′ as well as the dips f.

The band may then contact the bottom 24 of the tank and there results a risk of deterioration and of marking of the band by friction. Moreover, the traction load applied to the band must also be controlled in order to avoid premature wear and the deterioration of the back-up devices and for guiding the band inside the tanks, such as pinching rolls, thresholds of tanks or others.

To control the traction loads and, consequently, the dips taken by the catenary curve formed inside each tank, the treatment section 2 is therefore connected to two tensioning devices 6, 6′ placed respectively upstream and downstream, in the running direction, of the input 20 and output 20′ ends of the treatment section 2.

The upstream tensioning device 6 comprises thus an upstream tensioner 61 of the “S-block” type comprising at least two rolls with parallel axes whereon the band follows an S-shaped course and leads to a guiding device 62 which enables to maintain the band cambered correctly at the input 20 in the first treatment tank 5a.

Similarly, the downstream tensioning device 6′ comprises a guiding block 62′ enabling to keep the centring of the band at the output 20′ of the rinsing section 22 and a tensioning block 62′.

The upstream tensioner 61 thus enables, on the one hand to drive the band into the feeding section 1 and, on the other hand, to retain the band which is driven by the downstream tensioner 61′. The torques applied by both tensioners 61, 61′ are adjusted in relation to one another in order to control the traction load applied to the band.

It is generally foreseen to shear the edges of the band which may exhibit defects and edge shears 63 are therefore placed at the output of the treatment section. These edge shears 63 which may be of the pulled type are placed advantageously between the tensioning devices 61′ which enable to pull the band and the guiding block 62′ which enables to centre the band in the shears in order to minimise the edge waste.

The discharge section 3 placed downstream of the tensioning device 61′ comprises, conventionally, a coiler 30 connected, on the one hand to shears 31 enabling to cut the band upon completion of a winding cycle of a coil 41′ and, on the other hand, to means for withdrawing the completed coil and a means for engaging the head of the band for winding a new coil. Such means are well known and are therefore not represented on the drawing.

As the installation is foreseen to enable the band to be treated to run continuously, it is necessary, as seen above, to connect the tail of a band upon completed running to the head of the following coil.

To do so, the following steps are necessary: cropping the tail of band in the shears 13, placing a new coil on the uncoiler 10, engaging the new band in the unwinding devices 11 and 12, cropping the head of said new band and connecting said head to the tail of the preceding band by means of a junction device 14.

Throughout the time necessary to this replacement cycle, the running of the band must be stopped in the feeding section 1, but must carry on, conversely, in the treatment section 2 since a stoppage in the acid tanks would be detrimental to the quality of the band and bring about a loss of metal.

It is therefore necessary to provide, at the output of the feeding section 1, an accumulation device 15 wherein sufficient band length is put aside at the beginning of the unwinding cycle of a coil. To enable efficient control of the traction load on the band in the treatment section 2, this accumulator 15 must be placed upstream of the tensioner 61 which retains the band driven by the downstream tensioner 61′.

Similarly, a second accumulation device must be provided upstream of the coiler 30 to put aside the band length coming out of the treatment section 2 during the stoppage of the winding cycle for the discharge of a completed coil.

As indicated above, in a large production installation, the band runs at very high speed, for example 250 m/min and this speed must be maintained as constant as possible so as not to disturb the processing of the installation. Consequently, accumulators having a very large capacity must be used, said accumulators being each connected to two tensioners and, thus, only high production enables to render profitable such an expensive installation.

In the case, conversely, of small or medium capacity installation which must be adaptable to changes in the programme of manufacture, it is less important to maintain the productivity and, for the installation to be profitable, the investment and operation costs thereof must therefore be reduced. Consequently, until now, so-called “push-pull” installations were currently used, operating from one coil to the next.

In such an installation, the band of each coil must be re-engaged between all the rolls and this causes a risk of marking of the band. Moreover, the productivity is obviously rather low, because of the periodical stoppage of the installation.

The invention is based on the idea that by accepting a certain loss of productivity with respect to the continuous line treatment installations realised until now for large capacities, simpler and less costly arrangements could be used, such arrangements enabling, however, to keep most advantages of a continuous treatment. Thus, it will be possible to reduce the investment and operation costs sufficiently for such an installation to be profitable for a medium production, for example of 500,000 to 750,000 tons/year.

In particular, though very large capacity accumulators had been used until now, to maintain substantially constant the running speed in the tanks, it appears now that a reduction of the running speed down to a minimum speed for example of 10 m/min enables to use a very simple and cheap accumulator having a small capacity.

It is known, indeed, that the stoppage time necessary for a replacement or discharge cycle of a coil is approximately 1.5 minutes. If the running speed may be reduce down to its minimum value, for example 10 m/min, the capacity of the accumulator must be, simply, 15 to 20 m.

Besides, even in large capacity installations, it is already possible, for example in case of breakdown, to reduce the running speed to a very low value, in particular to realise hydrochloride pickling. In the invention, instead of being exceptional, such a reduced speed will appear periodically at the completion of each coil. This causes, obviously, a loss of productivity but the former remains quite acceptable for a small or medium capacity installation and, anyway, the production capacity remains greater than that of a “push pull” installation.

Therefore, small capacity accumulators will be used, as well upstream as downstream of the treatment section 2.

Preferably, as represented on FIG. 1, the accumulator 15 placed upstream of the input tensioner 61 of the treatment section 2, may be of the “looping pit” type.

It is known, indeed, that such an accumulator is particularly economical since it is composed simply of one or two pits 16 wherein the band forms a loop which hangs freely under the effect of its own weight. The band length thus accumulated in each pit is controlled by pinching rolls 17 whereof the speeds may be adjusted in relation, on the one hand, to the running speed at the output of the uncoiler 10 and, on the other hand, to the running speed maintained in the treatment section 2 by the tensioner 61. Thus, at the beginning of the unwinding of a coil, it is possible to adjust the speed given by the pinching rolls 17 a little above the running speed in the tanks in order to form loops 42 in both pits 16 which are fitted with band detection devices in order to control the lengths accumulated.

As already indicated, in the case of a significant deflection with respect to the span, the tension of the band need not be controlled with great accuracy. The general traction level is therefore determined simply by adjusting the relative speeds of the tensioner 61 placed upstream of the feeding section and pinching rolls 11 and 17.

Obviously, other known means could be used in the feeding section which need not be described in detail. However, inasmuch as the installation according to the invention is foreseen for small or medium capacity lines, it is interesting to reduce the investment by using less costly equipment than in a large production installation and enabling, however, to obtain the quality requested. In this view, it is interesting to use a stapler 14 for the connection of the successive bands but, if needed, another junction means may be used, such as, for example, a welding machine.

Similarly, a small capacity accumulator must be placed downstream of the treatment section 2. However, according to another essential feature of the invention, this accumulator 5 is integrated to the downstream tensioning device 6′ and is therefore placed between the output end of the treatment section 2 and the downstream tensioner 61′. Thus, whereas previously, a large capacity accumulator was placed downstream of the output tensioner of the treatment section, in the invention, said accumulator 5 is placed upstream of this tensioner 61′ since it may have a relatively small capacity and may be arranged to maintain the tension in the treatment section 2 at a constant level.

Such an accumulator 5 enables therefore, not only to absorb the band length produced during a discharge cycle, but also to keep constant, permanently, the band length between both tensioners 61, 61′ and, consequently, the lengths and the dips in each tank 21.

As indicated above, the normal duration of a discharge cycle after complete winding, of a coil 41′ is approximately 1.5 minutes. If the running speed is reduced to 10 m/min, the capacity of the accumulator 5 must therefore be in the order of 15 to 20 m and, anyway, a few tens of metres at the most.

Consequently, as represented schematically on the figure, the accumulator 5 may be of the dancing roller type comprising a single intermediate roll 51 connected to two fixed rolls 52, 52′ and movable over a length of some ten metres.

Preferably, the intermediate roll 51 moves horizontally beneath the rinsing section 22, one of the fixed rolls 52 being fixed at the output of the feeding section 2 and the other fixed roll 52′ belonging to the centring device 62′ placed ahead of the downstream tensioner 61′.

Thanks to this arrangement, the tension applied to the band 4 in the pickling tanks 21, which determines the level of the lower section 43 of the curve formed, in each tank, by the band, depends only on the torques applied respectively to the downstream tensioner 61′ which determines the driving load and to the upstream tensioner 61 which exerts a retaining load and is separate by no device than an intermediate roll from the input 20′ of the first tank, which enables to control with precision the traction load on the band.

The dancing roll 51 of the downstream accumulator 5 is, preferably, actuated by one or several jacks, not represented, connected to a hydraulic control system which enables to react without delay to any variation in the traction load applied between both tensioners 61, 61′ resulting, for example, from the dynamic effect of a variation in the speed, in the acceleration or deceleration phases.

The accumulator 5 provides therefore a traction regulation device enabling to keep constant the band length between both tensioners 61, 61′ and, consequently, the dip f of the catenary curve followed by the band in each tank.

The installation which has just been described operates therefore as follows:

After having placed a coil 41 on the uncoiler 10, the band 4 is unwound and passes through the successive sections of the installation until engagement of this head on the coiler 30. The installation may then operate continuously at normal running speed in the tanks, for example 200 m/min. The torques applied respectively by both tensioners 61, 61′ are adjusted in order to apply to the band, at the ends 23, 23′ of each tank 21, traction loads compatible with the stress level admissible by the material composing the band, while keeping a minimum distance between the bottom 24 of the tank 21 and the lower section 43 of the band.

At the beginning of the unwinding of the coil 41, the speeds of the pinching rolls 17 are adjusted in order to form, in each pit 16, a loop 42. Conversely, the dancing roll 51 of the downstream accumulator 5 is placed in its minimum accumulation retracted position with, however, a certain possibility of horizontal movement in order to compensate for, if needed, slight variations in the traction load applied to the band.

At the completion of the unwinding of the coil 41, the former must be replaced with a new coil. During the replacement cycle the running of the band is stopped at the shears 13 in order to cut off the tail of the band, and the running speed in the tanks 21 is reduced to a minimum speed in the order of 10 m/min for which the lengths of loops 42 accumulated previously in the pits 16 are sufficient to pursue the treatment.

In conventional installations, a variation in speed at the input or at the output of the line is compensated for by an accumulator connected to its own tensioners and of capacity sufficient to maintain constant the running speed in the treatment section whereof the tensioners need not therefore change speed.

Conversely, in the simplified installation according to the invention, only two tensioners 61, 61′ are necessary, the speeds of which may be modified simultaneously to slow down to the minimum of running speed or to go back to normal speed, while maintaining constant the traction load applied to the band.

Still, such adaptation is not immediate, considering the inertia of the driving devices.

There results a risk of variation in the tension and, consequently, of increase in the dip of the catenary in each tank. This risk is avoided, according to the invention, thanks to the hydraulic control of the downstream accumulator 5 which performs a true regulation. Any variation in the traction load may, indeed, be detected immediately and compensated for by a corresponding movement of the dancing roll 51 in order to keep constant the length of the band between the input 20 and the output 20′ of the feeding section 2 as well as the traction load applied to the band. Thus, when the running speed in the tanks 21 is reduced to enable to stop in the feeding section 1, the deceleration is absorbed by a slight movement of the dancing roll 51 which enables to keep constant the length and the dip f of the catenary formed by the band 4 in each tank 21 and, thereby to avoid any deterioration of the band by friction with the bottom 24 of the tank, even if a minimum safety distance is maintained.

After welding the tail of the band being treated on the head of a the new coil, the running speed is increased but the dynamic effect of this acceleration is further absorbed by the dancing roll 51 whereof the movement enables to keep constant the traction loads and the band length between both ends 23, 23′ of each tank 21.

When the coil 41′ formed on the coiler 30 reaches its maximum diameter, the running speed in the tanks 21 is again reduced to a minimum speed, for example 10 m/min, and the running is stopped at the downstream shears 31 which cut the band to enable the discharge of the completed coil 41′ then the engagement of the following section of the band on the coiler 30 to form a new coil.

As previously, the accumulator 5 has enabled to absorb such deceleration in order to keep constant the length of each catenary, in spite of the inertia of the driving devices. Then, the intermediate roll 51 may move in order to absorb the band length treated in the section 2 at such reduced speed, whereas this length can be, as already seen, 15 to 20 m for a stoppage time of 1.5 min.

Thus, the downstream accumulator 5 placed between the output 20′ of the treatment section and the downstream tensioner 61′ fulfils both functions, respectively to maintain, permanently, substantially constant a band length between both ends of each tank and to put aside a band length constant running in the treatment section 2 at a minimum speed during the discharge cycle of the completed coil.

When the running speed has come back to its normal level, the band unwinds continuously between the uncoiler 10 and the coiler 30 and the intermediate roll 51 of the accumulator 5 is brought back to minimum accumulation position without any modification of the traction load applied to the band by the tensioner 61′.

Obviously, the invention is not limited to the details of the embodiment which has just been described for exemplification purposes, since other devices can be used for the implementation of the method without departing from protection framework defined by the claims.

For example, it is advantageous and particularly economical to use looping pits to constitute the upstream accumulator 15 but other arrangements could be used to fulfil the same function, for example a dancing roll.

Besides, a horizontally movable dancing roll, enables to reduce the space requirements but it would be possible, obviously, to use a roll which is movable vertically.

Similarly, the guiding devices 62, 62′ may be fitted with two or three rolls and the tensioning devices 61, 61′ with two or four rolls. The fractioning shears 13, 31 may also be of any type suited to the capacity of the line, to the running speeds requested and to the nature of the materials to be processed. The same applies to the pickling system used, for example a shallow flat tank or a tank with injection of acid, as well as means enabling to reduce the running speed down to a level compatible with an accumulation capacity reduced to a few tens of metres. In this view, it is known, in particular, that advantageously, hydrochloride pickling may be performed and inhibiters may also be used to mitigate the effect of the acid in order not to attack the metal unduly at reduced speed.

Besides, the invention is aimed especially for the realisation of medium capacity continuous pickling lines, for example in the order of 500,000 à 750,000 tons per annum. However, the invention may also provide advantages for larger capacity lines since the traction regulation provided by the dancing roll would enable to use shallow tanks with a very taut band, without any risk of deterioration thereof.

1. A method for driving a band product running, along a longitudinal direction, through an installation comprising at least three successive sections, respectively a feeding section (1), a treatment section (2) by passing the band (4) in at least one oblong tank (21) containing a treatment fluid and having an input (23) and an output (23′) placed at an upper level, between which the running band forms a curve (40) having a lower section (43) placed at a lower level which depends on the band length situated between the input and the output of the tank (21), and a discharge section (3), said treatment section (2) being connected to an upstream tensioner (61) and to a downstream tensioner (61′) placed respectively ahead of the input end (20) and behind the output end (20′) of the treatment section (2), said method comprising the steps of compensating for immediately any variation in the running speed in the treatment section (2), at least during an acceleration or deceleration phase, by a corresponding variation in the band length (44) situated between the output end (20′) of the treatment section (2) and the downstream tensioner (61′) and, thus, maintaining permanently a band length substantially constant between said output end (20′) of the treatment section (2) and the upstream tensioner (61), without any significant variation in the traction load applied to the band (4) between both tensioners (61, 61′).

2. A method according to claim 1, comprising the steps of detecting any possible variation in the traction load applied to the band between both tensioners, respectively upstream (61) and downstream (61′), due to the dynamic effect of a variation in the running speed, and absorbing immediately such detected variation by accumulating a corresponding variable band length in an accumulation device (5) interposed between the output (20′) of the treatment section (2) and the downstream tensioner (61′).

3. A method according to claim 2, for driving a band (4) in an installation wherein the discharge section (3) comprises a coiler (30) for winding the band (4) upon completion of the treatment, said method comprising the steps of stopping the running of the band (4) upon completion of a winding cycle of a coil throughout a discharge cycle of the wound coil (41′), reducing, throughout said discharge cycle, the running speed in the treatment section (2) to a minimum value and putting aside the band length running at said minimum speed throughout the discharge cycle, while maintaining the traction load, in an accumulator (5) of corresponding capacity, interposed between the output end (20′) of the treatment section (2) and the downstream tensioner (61′).

4. A method according to one of the previous claims, for driving a band in an installation wherein the feeding section (1) comprises means (10, 11) for unwinding a coil (41) to be processed, said method comprising the steps of stopping the running of the band (4) upon completion of the unwinding cycle of the coil (41) for the replacement thereof with a new coil, reducing, throughout said replacement cycle, the running speed in the treatment section (2) to a minimum value and putting aside the band length running at said minimum speed throughout the replacement cycle in an accumulator (15) whereof the capacity corresponds to said minimum speed, said accumulator (15) being interposed between the output (20′) of the feeding section (1) and the upstream tensioner (61).

5. A method according to one of the claims 3 and 4, wherein throughout a coil replacement or discharge cycle, the running speed in the treatment section (2) is reduced to a minimum value corresponding to an accumulation capacity of a few tens of metres at the most.

6. An installation for treatment a band product comprising:
means (11, 61, 61′, 30) for controlling the running of a band (4), along a longitudinal axis, in at least three successive sections, respectively:
a feeding section (1) of the band at adjustable speed between a zero speed and a treatment speed;
a treatment section (2) having an input end (20) and an output end (20′) and comprising at least one oblong tank (21) having an input (23) and an output (23′) and containing a treatment fluid;
a discharge section (3) of the band at adjustable speed between a normal speed and a zero speed;
two tensioner assemblies, respectively an upstream tensioner (61) placed ahead, in the running direction, of an input end (20) of the treatment section (2) and a downstream tensioner (61′) placed behind an output end (20′), for maintaining said band (4) under substantially constant traction load between the input (23) and the output (23′) of each tank,
wherein said installation comprises an accumulation device (5) for controlling a variation in the band length (44) running between the output end (20′) of the treatment section (2) and the downstream tensioner (61′), said accumulation device (5) maintaining, permanently, a band length (40) substantially constant between said output end (20′) and the upstream tensioner (61), without any significant variation in the traction load applied to the band (4) between both tensioners, respectively upstream (61) and downstream (61′).

7. An installation according to claim 6, wherein at least one accumulator (15) of the looping pit type is placed on the path of the band (4), at the output of the feeding section (1) and ahead of the upstream tensioner (61).

8. An installation according to claim 6, wherein the accumulation device (5) placed between the output (20′) of the treatment section (2) and the downstream tensioner (61′) constitutes, on the one hand a means for regulating the traction applied to the band for maintaining, permanently, a band length substantially constant between the input ends (23) and output ends (23′) of each tank (21) and, on the other hand, a means for reserving a band length sufficient for maintaining the running of the band (4) in the treatment section (2) throughout a stoppage time in the discharge section (3) of the installation.

9. An installation according to claim 8, wherein the discharge section (3) comprises a coiler (30) connected to means for discharging a wound coil (41′), and wherein the accumulation device (5) has a maximum accumulation capacity corresponding to a band length running for the duration of a discharge cycle of a coil (41′), at reduced running speed in the treatment section (2).

10. An installation according to claim 9, wherein the accumulation device (5) has a maximum accumulation capacity of a few tens of metres.

11. An installation according to one of the claims 4 to 10, wherein the accumulation device (5) is controlled hydraulically for adjusting the band length accumulated.

12. An installation according to one of the claims 4 to 11, wherein the band accumulation device (5) comprises an intermediate roll (51) movable between two accumulation positions, respectively maximum and minimum.

13. An installation according to claim 12, wherein the movement of the intermediate roll (51) is controlled by at least one hydraulic jack connected to a feeding circuit comprising means for detecting any variation in the traction load applied to the band (4) running over the roll (51).

14. An installation according to one of the claims 12 and 13, wherein the intermediate roll (51) moves horizontally between a minimum accumulation retracted position and a maximum accumulation extended position.

15. An installation according to one of the claims 12 and 13, wherein the intermediate roll (51) moves vertically between a minimum accumulation retracted position and a maximum accumulation extended position.

16. An installation according to one of the claims 6 to 15, comprising means (62, 62′) for guiding the band (4) placed respectively between each end (20, 20′) of the treatment section (2) and the corresponding tensioner assembly (61, 61′).
